(19) United States
(12) Patent Application Publication
(10) Pub. No.: US 2013/0117633 A1
(43) Pub. Date: May 9, 2013

(54) RECORDING APPARATUS, WRITING APPARATUS, AND READING APPARATUS

(71) Applicants: Shinichi MATSUKAWA, Tokyo (JP); Akihiro Kasahara, Sambu-gun (JP); Hiroyuki Sakamoto, Ome-shi (JP)

(72) Inventors: Shinichi MATSUKAWA, Tokyo (JP); Akihiro Kasahara, Sambu-gun (JP); Hiroyuki Sakamoto, Ome-shi (JP)

(21) Appl. No.: 13/729,774

(22) Filed: Dec. 28, 2012

Related U.S. Application Data
(63) Continuation of application No. PCT/JP2011/057506, filed on Mar. 28, 2011.

(30) Foreign Application Priority Data
Jun. 30, 2010 (JP) 2010-150042

(51) Int. Cl. G06F 11/10

(52) U.S. Cl. CPC G06F 11/10
USPC 714/763

(57) ABSTRACT

According to one embodiment, a recording apparatus includes a memory and a controller. The memory is capable of recording data. The controller divides the memory into a first region and a second region and controls the recording of the data. The controller writes externally supplied data into the first region without performing error correction coding and address conversion of a logical address into a physical address for the externally supplied data, and performs the error correction coding and the address conversion for the data, and then writes resulting data into the second region.

### CROSS-REFERENCE TO RELATED APPLICATIONS

This application is a Continuation application of PCT Application No. PCT/JP2011/057506, filed Mar. 18, 2011 and based upon and claiming the benefit of priority from Japanese Patent Application No. 2010-150042, filed Jun. 30, 2010, the entire contents of all of which are incorporated herein by reference.

### FIELD

Embodiments described herein relate generally to a recording apparatus, a writing apparatus, and a reading apparatus.

### BACKGROUND

Content distribution making use of recording media, such as SD™ memory cards, is known. In such a content distribution system, content protection technology for preventing illegal content copying is important.

### BRIEF DESCRIPTION OF THE DRAWINGS

FIG. 1 is a block diagram of a recording apparatus and a writing apparatus according to a first embodiment;

FIG. 2 is a block diagram of a recording apparatus and a reading apparatus according to the first embodiment;

FIGS. 3 and 4 are flowcharts to explain the operation of the writing apparatus and reading apparatus according to the first embodiment, respectively;

FIGS. 5 and 6 are conceptual diagrams to explain concrete examples of a writing method and a reading method according to the first embodiment, respectively;

FIG. 7 is a block diagram of the recording apparatus according to the first embodiment;

FIGS. 8 and 9 are block diagrams of a recording apparatus according to a second embodiment;

FIG. 10 is a table showing a method of controlling the recording apparatus according to the second embodiment;

FIG. 11 is a conceptual diagram of a memory space of the recording apparatus according to the second embodiment;

FIG. 12 is a flowchart to explain the operation of the recording apparatus according to the second embodiment;

FIG. 13 is a block diagram of a recording apparatus and a writing apparatus according to a third embodiment;

FIG. 14 is a block diagram of a recording apparatus and a reading apparatus according to the third embodiment;

FIG. 15 is a block diagram of a recording apparatus according to a fourth embodiment;

FIG. 16 is a block diagram of a drive control circuit according to the fourth embodiment;

FIG. 17 is a block diagram of a processor according to the fourth embodiment;

FIG. 18 is a perspective view of a personal computer according to the fourth embodiment, showing the appearance of the personal computer; and

FIG. 19 is a block diagram showing an internal configuration of the personal computer according to the fourth embodiment.

### DETAILED DESCRIPTION

In general, according to one embodiment, a recording apparatus includes a memory and a controller. The memory is capable of recording data. The controller divides the memory into a first region and a second region and controls the recording of the data. The controller writes externally supplied data into the first region without performing error correction coding and address conversion of a logical address into a physical address for the externally supplied data, and performs the error correction coding and the address conversion for the data, and then writes resulting data into the second region.

### First Embodiment

A recording apparatus, a writing apparatus, a reading apparatus, and a method of controlling the recording apparatus according to a first embodiment will be explained. Hereinafter, the recording apparatus will be explained, taking an SD memory card (hereinafter, simply referred to as a memory card) as an example.

1. Configuration of Memory Card

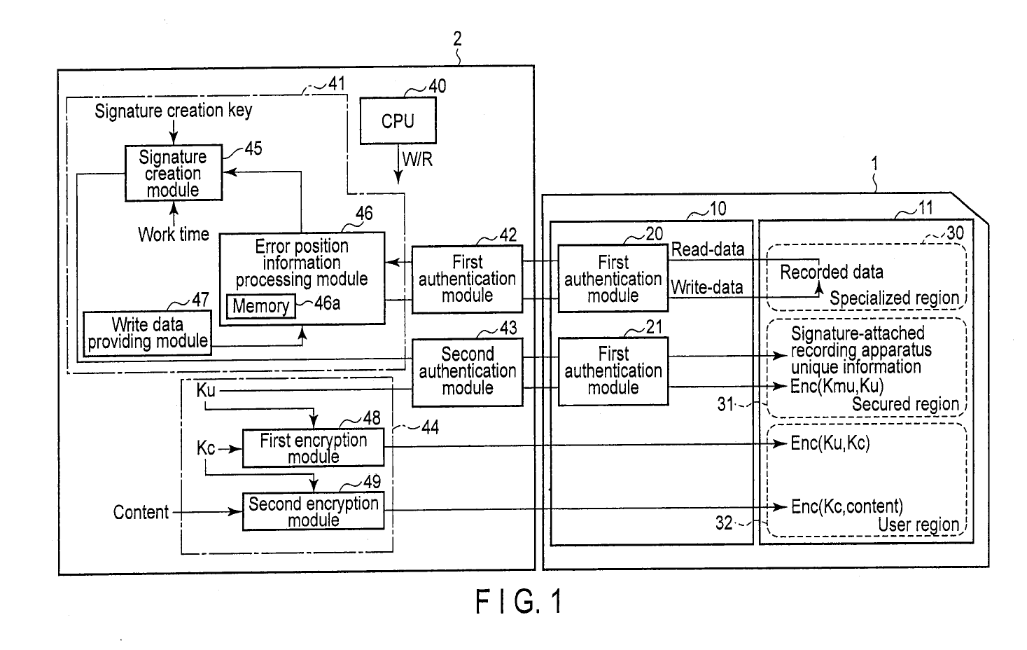

The configuration of a memory card according to the first embodiment will be described briefly with reference to FIG. 1. It will be explained in detail later in a second embodiment. FIG. 1 is a block diagram of a memory card and a writing apparatus.

As shown in FIG. 1, a memory card 1 includes a memory controller 10 and a NAND flash memory 11. The memory controller 10 and NAND flash memory 11 may be formed on separate substrates or on a single substrate.

The memory controller 10 performs processes necessary to write data into the NAND flash memory 11, read data from the NAND flash memory 11, or erase data in the NAND flash memory 11 according to an access from a host apparatus (a writing apparatus or a reading apparatus in the embodiment) to which the memory card 1 is connected.

The memory controller 10 includes a first authentication module 20 and a second authentication module 21. The first authentication module 20 and the second authentication module 21 execute an authentication process of the memory card 1 in cooperation with the host apparatus. By this authentication process, the host apparatus is permitted to access the memory card 1.

In addition, the memory controller 10 divides the memory area of the NAND flash memory 11 into at least three regions and manages them. The three regions are a specialized region 30, a secured region 31, and a user region 32. When the host apparatus is authenticated at the first authentication module 20, the memory controller 10 permits the host apparatus to access the specialized region 30. When the host apparatus is authenticated at the second authentication module 21, the memory controller 10 permits the host apparatus to access the secured region 31. To access the user region 31, the authentication of the host apparatus is not needed.

In the secured region 31, recording apparatus unique information (hereinafter, simply referred to as unique information) is recorded. Unique information is information unique to the NAND flash memory 11 of each memory card 1, more specifically, information on a place where an error is liable to occur when data is written into the NAND flash memory 11. The unique information is generated by the writing apparatus 2 of the memory card 1 and recorded in the secured region 31. The specialized region 30 is a region used by the writing apparatus 2 to generate unique information. The user region 32 is a region in which net user data is stored. Various contents data, including music data and movie data, are recorded in the user region 32. One of the encryption keys used to encrypt the contents data may be recorded in the user region 32. In addition, another encryption key may be recorded in the secured region 31.

2. Configuration of Writing Apparatus 2

Next, the configuration of the writing apparatus 2 according to the first embodiment will be explained with reference to FIG. 1. The writing apparatus 2 generates unique information and writes the information into the memory card 1 and further writes various contents into the memory card 1.

The writing apparatus 2 may be, for example, a Kiosk terminal or a content provider that provide various contents. The writing apparatus 2 may be a recording and reproducing equipment for contents, such as movies, distributed via the Internet or the like. As shown in FIG. 1, the writing apparatus 2 roughly includes a CPU 40, a generation module 41, a first authentication module 42, a second authentication module 43, and a content encryption module 44.

The CPU 40 controls the operation of the entire writing apparatus 2. The CPU 40 issues a write-command when the writing apparatus writes data and a read-command when the writing apparatus read data.

The first authentication module 42 performs an authentication process in cooperation with the first authentication module 20 of the controller 10 when the writing apparatus accesses the specialized region 30 of the NAND flash memory 11 of the memory card 1.

The second authentication module 43 performs an authentication process in cooperation with the second authentication module 21 of the controller 10 when the writing apparatus accesses the secured region 31 of the NAND flash memory 11 of the memory card 1.

The generation module 41 generates unique information according to an instruction from the CPU 40 and writes the information into the memory card 1. The generation module 41 includes a signature generation module 45, an error position information processing module 46 (hereinafter, simply referred to as a processing module 46), and a write-data providing module 47 (hereinafter, simply referred to as a providing module 47). The providing module 47 generates data to be written into the specialized region 30 of the NAND flash memory 11 when unique information is generated. The processing module 46 writes data generated by the providing module 47 into the specialized region 30 and reads the written data. Then, the processing module 46 generates unique information on the basis of the difference between the written data and the read data and transfers the unique information to the signature generation module 45. The signature generation module 45 attaches a digital signature to the unique information on the basis of an externally supplied (or internally generated) signature generation key. Then, the signature generation module 45 writes the digital-signature-attached unique information into the secured region 31 of the NAND flash memory 11.

The content encryption module 44 encrypts content to be recorded in the user region 32 of the memory card 1 and a content key. The method disclosed in Jpn. Pat. Appln. KOKAI Publication No. 2005-341156 included in this specification by reference may be applied to the process at the content encryption module 44. One example of this will be explained later as a third embodiment.

3. Configuration of Reading Apparatus

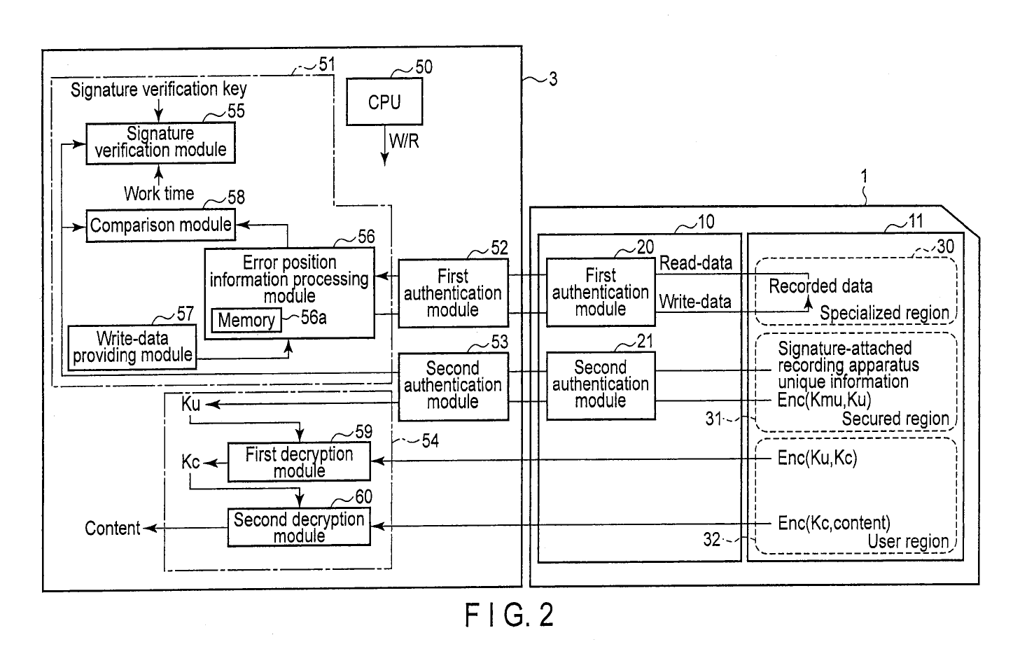

Next, the configuration of the reading apparatus according to the first embodiment will be explained with reference to FIG. 2. FIG. 2 is a block diagram of the memory card and reading apparatus.

The reading apparatus is an apparatus that reproduces content provided by, for example, a Kiosk terminal or a content provider. In a system that distributes contents, including movies, via the Internet or the like, the reading apparatus and writing apparatus may be combined to form a single apparatus (or integrated into a single apparatus). As shown in FIG. 2, the reading apparatus 3 roughly includes a CPU 50, a determination module 51, a first authentication module 52, a second authentication module 53, and a content decryption module 54.

The CPU 50 controls the entire reading apparatus 3. The CPU 50 issues a write-command when the reading apparatus writes data, and a read-command when the reading apparatus reads data.

The first authentication module 52 performs an authentication process in cooperation with the first authentication module 20 of the controller 10 when the reading apparatus accesses the specialized region 30 of the NAND flash memory 11 of the memory card 1.

The second authentication module 53 performs an authentication process in cooperation with the second authentication module 21 of the controller 10 when the reading apparatus accesses the secured region 31 of the NAND flash memory 11 of the memory card 1.

The determination module 51 generates recording apparatus unique information (hereinafter, simply referred to as unique information) according to an instruction from the CPU 50. On the basis of the generated unique information and the unique information written in the memory card 1 by the writing apparatus 2, the determination module 51 determines whether the memory card 1 is a legitimate recording medium, in other words, whether or not the memory card 1 is a clone medium. Hereinafter, to distinguish between them, unique information generated by the writing apparatus is referred to as first unique information and unique information generated by the reading apparatus 3 is referred to as second unique information. As shown in FIG. 2, the determination module 51 comprises a signature verification module 55, an error position information processing module 56 (hereinafter, simply referred to as a processing module 56), a write-data providing module 57 (hereinafter, simply referred to as providing module 57), and a comparison module 58.

The providing module 57 generates data to be written into the specialized region 30 of the NAND flash memory 11 when second unique information is generated. The processing module 56 writes data generated by the providing module 57 into the specialized region 30 and then reads the written data. Then, the processing module 56 generates second unique information on the basis of the difference between the written data and the read data and transfers the second unique information to the comparison module 58. The signature verification module 55 reads the first unique information from the specialized region 31 of the NAND flash memory 11. Then, on the basis of an externally supplied (or internally generated) signature verification key, the signature verification module 55 verifies whether the digital signature attached to the first unique information is correct and outputs the verification result to the CPU 50. The comparison module 58 reads the first unique information from the secured region 31 of the NAND flash memory 11. Then, the comparison module 58 compares the first unique information with the second unique information supplied from the processing module 56 and determines on the basis of the comparison result whether the memory card 1 is a legitimate recording medium. Then, the comparison module 58 outputs the determination result to the CPU 50.

The content decryption module 54 reads the content and content key from the user region 32 of the memory card 1 and then decrypts these pieces of information. The method disclosed in Jpn. Pat. Appln. KOKAI Publication No. 2005-341156 incorporated in this specification by reference may be used for the process at the content decryption module 54. One example of the method will be explained later as a third embodiment.

4. Operation of Writing Apparatus 2

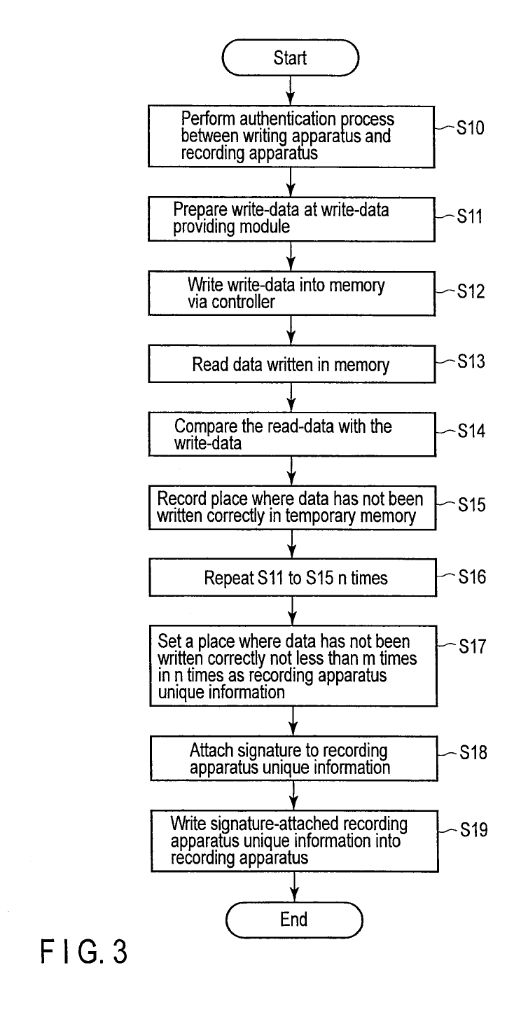

Next, the operation of the writing apparatus 2 when the first unique information is generated and written into the memory card 1 will be explained with reference to FIG. 3. FIG. 3 is a flowchart to explain the operation of the writing apparatus 2.

As shown in FIG. 3, first, in response to an instruction from the CPU 40, the first authentication module 42 performs an authentication process in cooperation with the first authentication module 20 of the memory card 1 (step S10). An authentication process performed between a device (the writing apparatus 2 of the first embodiment) and an SD memory card disclosed in, for example, reference document (CPRM Specification for SD Memory Card 4C Entity, LLC, <URL: http://www.4 centity.com>) may be used as the authentication process.

The authentication process will be explained briefly. The writing apparatus 2 and memory card 1 both have the same confidential information called a media unique key. Each of the writing apparatus 2 and memory card 1 hands a random number generated each time to the other party, processes the received value by a specific method on the basis of a media unique key, and returns the resulting value to the other party. Then, the returned value is verified. If the verification has shown that the process has been performed properly, it is determined that the other party has the same confidential information. That is, it has been determined that the other party is an authenticated recipient. In the reference document, the device reads a media key block and a media ID recorded in the memory card 1 and carries out a specific procedure with a device key set the device has, thereby forming a media unique key. The same value as that of the media unique key is also held in the memory card.

The authentication process may be carried out by a Public Key Infrastructure (PKI) method. In the PKI method, when the device authenticates the validity of the recipient, it performs processing as follows. When the device performs communication, it has a pair of a secret key and a public key with an asymmetric cipher algorithm, in cooperation with the recipient. The device transmits a random number generated each time to the recipient. Then, the recipient encrypts the received random number with a secret key and sends back the encrypted random number and a public key. When having received these, the device decrypts the encrypted random number with the public key. When the decrypted random number coincides with a random number generated by the device, it determines that the recipient is a party that is the owner of the secret key. That is, it determines that the party is an authenticated recipient. The process is performed at each of the device side and the recipient side. As an example, the authentication method implemented between a host apparatus and a drive unit written in reference document (Advanced Access Content System (AACS) Introduction and Common Cryptographic Elements Book, <URL: htt://www.aacsla.com/specifications/AACS_Spec_Common_FI NAL_{—}0951.pdf>) may be applied.

After the authentication process has been carried out by the above method, the providing module 47 generates and prepares write-data according to an instruction from the CPU 40 (step S11). The data may be predetermined specific data or data generated using a random number each time. The providing module 47 transfers the generated data to the processing module 46.

Next, according to an instruction from the CPU 40, the processing module 46 writes the received data into the specialized region 30 of the NAND flash memory 11 via the first authentication modules 42, 20 (step S12). At this time, the CPU 40 issues a write-command and an address for the specialized region 30.

Then, according to an instruction from the CPU 40, the processing module 46 reads the data from the specialized region 30 (step S13). At this time, the CPU 40 issues a read command and an address for the specialized region 30. Of course, the data read in step S13 is the data written in the immediately preceding step S12. An authentication process may be carried out between step S12 and step S13.

Next, the processing module 46 compares the data read in step S13 with the data written in step 12 (step S14). In the comparison, the processing module 46 detects a data position where the former data does not coincide with the latter, that is, the position of data not written correctly in (and/or read correctly from) the memory card 1 (or the position of an error). Then, the processing module 46 records the positional information in a temporary memory 46a (step S15). The temporary memory 46a may be located inside or outside the processing module 46. In addition, the temporary memory 46a may be a volatile semiconductor memory, such as a DRAM or an SRAM, or a nonvolatile semiconductor memory, such as a NOR flash memory.

The writing apparatus 2 repeats the processes in steps S11 to S15 a specific number of times (n times where n is a natural number not less than 2) (step S16). Each time the processes are repeated, the position of an error is additionally written into the temporary memory 46a. As a result, the position of an error is recorded in the temporary memory 46a for each of n writes. Before the specialized region 30 is written into repeatedly, the CPU 40 may issue an erase command and an address to the specialized region 30 to erase data in advance.

Thereafter, according to an instruction from the CPU 40, the processing module 46 refers to the temporary memory 46a and determines the position of an error where writing has failed not less than m times (m being a natural number not less than 2) in n writes to be first unique information (step S17).

Furthermore, according to an instruction from the CPU 40, the signature generation module 45 generates a digital signature using a digital signature generation key given to the writing apparatus 2 to prevent the first unique information from being altered and attaches the digital signature to the first unique information (step S18). A digital signature is a signature attached to digital information only a person who has specific confidential information can generate. It is based on a general information-theoretical method which permits others to verify that the signature is correct, but prevents them to counterfeit the signature. The method described in, for example, reference (Digital Signature Standard, FIPS186, <URL: http://www.itl.nist.gov/fipspubs/index.htm>) may be applied to digital signatures. In a digital signature, a digest value of data to be signed is encrypted on the basis of an asymmetric algorithm where an encryption key and a decryption key differ from each other and the encrypted data is treated as signature data. The digital signature is based on a method of decrypting signature data with a decryption key at the time of verification and, if the decrypted data coincides with the digest value of the data to be signed, it is determined that the digital signature is authentic. The method described in the above reference document is generally used.

Thereafter, according to an instruction from the CPU 40, the signature generation module 45 writes the signature-attached first unique information generated in step S18 into the secured region 31 of the NAND flash memory 11 (step S19). At this time, the CPU 40 issues a write-command and an address for the secured region 31.

Since the secured region 31 is accessed in step S19, an authentication process may be performed between step S18 and step S19. This process is carried out by the second authentication modules 21, 43.

After the signature-attached first unique information has been written into the memory card 1 by the processes in steps S10 to S19, the writing apparatus 2 then writes content into the memory card 1. The writing can be performed by a well-known method.

5. Operation of the Reading Apparatus 3

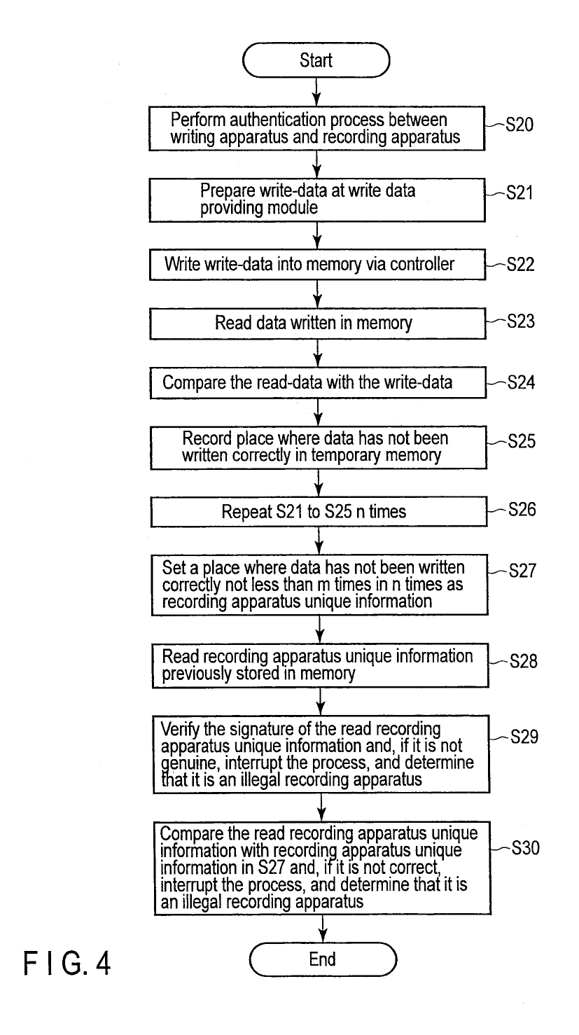

Next, the operation of the reading apparatus 3 in determining on the basis of the first unique information and second unique information whether the memory card 1 is a legitimate recording medium will be explained with reference to FIG. 4. FIG. 4 is a flowchart to explain the operation of the reading apparatus 3.

As shown in FIG. 4, in response to an instruction from the CPU 50, the first authentication module 52 carries out an authentication process in cooperation with the first authentication module 20 of the memory card 1 (step S20). An authentication method similar to that in step S10 explained in FIG. 3 may be applied to the authentication process.

Next, according to an instruction from the CPU 50, the providing module 57 generates and prepares write-data (step S21). The data may be predetermined specific data or data generated each time using a random number. In addition, the data may be equal to or different from the data generated by the providing module 47 of the writing apparatus 2. The providing module 57 then transfers the generated data to the processing module 56.

Next, according to an instruction from the CPU 50, the processing module 56 writes the received data into the specialized region 30 of the NAND flash memory 11 via the first authentication modules 52, 20 (step S22). At this time, the CPU 50 issues a write-command and an address for the specialized region 30.

Then, according to an instruction from the CPU 50, the processing module 56 reads the data from the specialized region 30 (step S23). At this time, the CPU 50 issues a read command and an address for the specialized region 30. Of course, the data read in step S23 is the data written in the immediately preceding step S22. An authentication process may be carried out between step S22 and step S23.

Next, according to an instruction from the CPU 50, the processing module 56 compares the data read in step S23 with the data written in step 22 (step S24). In the comparison, the processing module 56 detects a data position where the former data does not coincide with the latter, that is, the position of data not written correctly in (and/or read correctly from) the memory card 1 (or the position of an error). Then, the processing module 56 records the positional information in a temporary memory 56a (step S25). The temporary memory 56a may be located inside or outside the processing module 56. In addition, the temporary memory 56a may be a volatile semiconductor memory, such as a DRAM or an SRAM, or a nonvolatile semiconductor memory, such as a NOR flash memory.

The reading apparatus 3 repeats the processes in steps S21 to S25 a specific number of times (n times where n is a natural number not less than 2) (step S16). Each time the processes are repeated, the position of an error is additionally written into the temporary memory 56a. As a result, the position of an error is recorded in the temporary memory 55a for each of n writes. Here, n and m may be equal to or different from n and m used in the writing apparatus 2. Before repeating of the writing to the specialized region 30, the CPU 50 may issue an erase-command and an address for the specialized region 30 to erase data in advance.

Thereafter, according to an instruction from the CPU 50, the processing module 56 refers to the temporary memory 56a and determines the position of an error where writing has failed not less than m times (m being a natural number not less than 2) in n writes to be second unique information (step S27). The concrete processes in steps S20 to S27 are the same as those in steps S10 to S17 carried out by the writing apparatus 2.

Next, the signature verification module 55 and comparison module 58 read the first unique information from the secured region 31 of the NAND flash memory 11 (step S28). At this time, the CPU 50 issues a write-command and an address for the secured region 31. Since the secured region 31 is accessed in step S28, an authentication process may be performed between step S27 and step S28. This process is performed by the second authentication modules 21, 53.

Then, according to an instruction from the CPU 50, the signature verification module 55 authenticates the validity of the digital signature attached to the read first unique information. If the result of the verification has shown that the digital signature is not authentic, the CPU 50 interrupts the process and determines that the memory card 1 is an illegal recording medium, or a clone card (step S29). As a result, the reading apparatus 3 is prevented from accessing the memory card 1.

Furthermore, according to an instruction from the CPU 50, the comparison module 58 compares the read first unique information with the second unique information supplied from the processing module 56. If the result of comparison has shown that the former does not coincide with the latter, the CPU 50 interrupts the process and determines that the memory card 1 is an illegal recording medium, or a clone card (step S30). As a result, the reading apparatus 3 is prevented from accessing the memory card 1.

Then, if it has been determined in steps S29 and S30 that the memory card is a legitimate recording medium, the reading apparatus 3 starts to reproduce the content recorded in the user region 32 of the NAND flash memory 11. The reproduction may be performed by a well-known method.

6. Concrete Example of a Method of Authenticating Memory Card 1

Next, a concrete example of the operations described in FIGS. 3 and 4 will be explained. As described above, to verify whether the memory card 1 is a legitimate recording medium, the first unique information and second unique information are used. These pieces of information are generated using write-data generated by the providing modules 47, 57. The write-data is not limited to this. The amount of write-data is, for example, about 1 megabyte. Hereafter, to simplify explanation and facilitate understanding, a case where write-data contains 16 bits and each of the writing apparatus 2 and reading apparatus 3 is based on the assumption that n=5 and m=3 will be explained as an example.

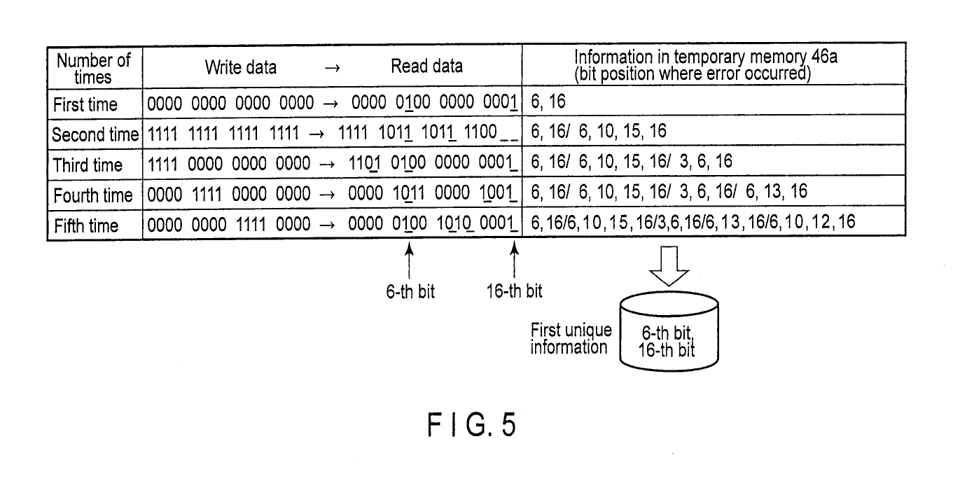

First, the writing apparatus 2 records the first unique information. This recording process will be explained with reference to FIG. 5. FIG. 5 is a table to explain write-data, read-data, data in the temporary memory 56a, and the first unique information in each of the repetitions of steps S11 to S15. In FIG. 5, the underlines in read-data items show bit positions different from those in write-data items.

As shown in FIG. 5, suppose write-data generated by the providing module 47 in a first write is (0000_{—}0000_{—}0000_{—}000) and what is read from the specialized region 30 after the write-data has been written in the region 30 is (0000_{—}0100_{—}0000_{—}0001). That is, a sixth bit and a sixteenth bit from the beginning of the read-data are inverted (erroneous). Therefore, the error positions (the sixth bit and sixteenth bit) are recorded in the temporary memory 44a.

Next, suppose (1111_{—}1111_{—}1111_{—}1111) is generated as write-data in a second write and what is read is (1111_{—}1011_{—}1011_{—}1100). Therefore, the error positions (the sixth bit, tenth bit, fifteenth bit, and sixteenth bit) are additionally recorded in the temporary memory 44a.

Next, suppose (1111_{—}0000_{—}0000_{—}0000) is generated as write-data in a third write and what is read is (1101_{—}0100_{—}0000_{—}0001). Therefore, the error positions (the third bit, sixth bit, and sixteenth bit) are additionally recorded in the temporary memory 44a.

Hereinafter, suppose a fourth write, a fifth write, and what are read are as shown in FIG. 5. Then, it is seen that error positions where bits have been inverted not less than m=3 times are the sixth bit and sixteenth bit. Therefore, the processing module 46 writes the error positions as first unique information into the secured region 31.

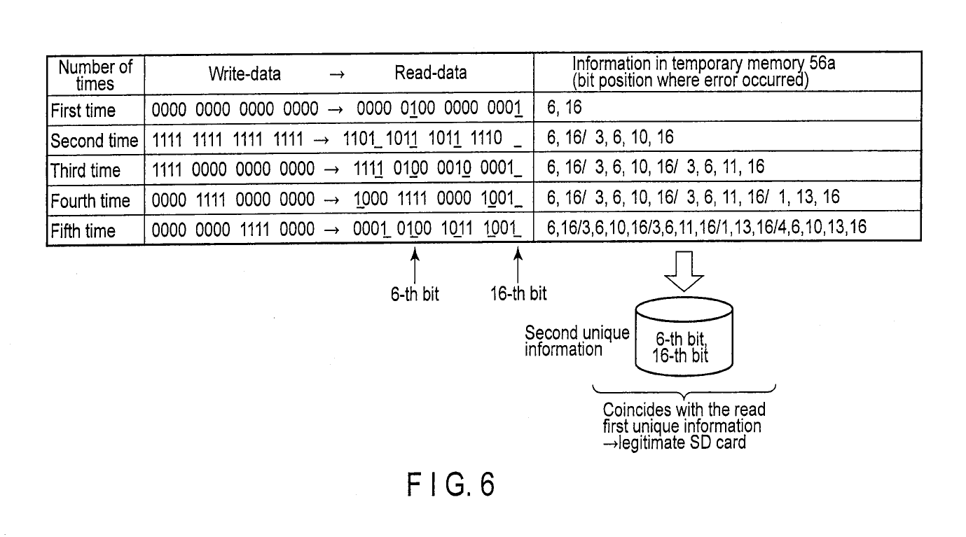

Next, the reading apparatus 3 generates second unique information and compares the first unique information with the second unique information. The comparison process will be explained with reference to FIG. 6. FIG. 6 is a table to explain-write data, read-data, data in the temporary memory 56a, and the second unique information in each of the repetitions of steps S21 to S25. In FIG. 6, the underlines mean the same thing as in FIG. 5.

As shown in FIG. 6, suppose the pattern of write-data is the same as that of FIG. 5. Suppose a sixth bit and a sixteenth bit have been inverted in a first read, a third bit, a sixth bit, a tenth bit, and a sixteenth bit have been inverted in a second read, and the rest is as shown in FIG. 6.

Then, it is seen that error positions where bits have been inverted not less than m=3 times are the sixth bit and sixteenth bit in the temporary memory 54. Therefore, the processing module 56 transfers the error positions as second unique information to the comparison module 58.

The comparison module 58 compares the first unique information of FIG. 5 with the second unique information of FIG. 6. Then, the first unique information and second unique information coincide with each other in error positions at the sixth bit and sixteenth bit. Therefore, the comparison module 58 determines that the memory card is a legitimate recording medium.

7. Effects of the First Embodiment

As described above, with the recording apparatus and its controlling method according to the first embodiment, unauthorized use of content data can be suppressed. This effect will be explained below.

With the recent development of the information society, a content distribution system which distributes content, such as computerized books, newspapers, music, or moving images, to user terminals and enables the users to browse the content has been widely used.

Computerized content (hereinafter, simply referred to as content) can be duplicated easily and therefore an illegal act is liable to be done by infringing copyright. To protect content from such an illegal act, content is generally encrypted with an encryption key and then recorded. The encrypted content is decrypted at the time of reproduction. This type of content protection technique includes Content Protection for Recordable Media (CPRM). In addition, an encryption double key method where a content key is encrypted doubly by two kinds of keys has been considered (e.g., refer to Jpn. Pat. Appln. KOKAI Publication No. 2005-341156). This type of encryption double key method is used in, for example, MQbic (a registered trademark). Of the encryption keys, a key unique to a recording medium, such as a media unique key, is stored securely in a secret region of a storage medium and cannot be externally accessed at all. Therefore, for example, even if only encryption content key data has been copied illegally, the person who has copied illegally cannot use the content data without the media unique key.

However, if such a media unique key has been read illegally by some method and handed to an illegal card manufacturer, clone cards made by copying a legitimate card start to appear, with the result that content data might be used illegally.

In this respect, with a memory card according to the first embodiment, it is determined on the basis of the recording apparatus unique information whether the memory card is a legitimate recording device. Accordingly, even if the media unique key has been read illegally, content can be prevented from being accessed. Consequently, the circulation of clone cards can be suppressed and content data can be protected effectively.

The recording apparatus unique information is information that indicates bit positions where the frequency of discrepancy between write-data and read-data becomes high as a result of writing data into the NAND flash memory and then reading the data. That is, the information shows the positions of particularly-low-performance memory cells in a memory chip in which the NAND flash memory 11 has been formed. The positions of poor-performance memory cells in the memory chip, of course, differ from one memory chip to another. Accordingly, the recording apparatus unique information is also information unique to each NAND flash memory 11.

For example, when content is written, first unique information is generated and written into a memory card. Thereafter, when content is reproduced, second unique information is generated and compared with the first unique information. If the second unique information coincides with the first unique information, the memory card is treated as a legitimate recording apparatus.

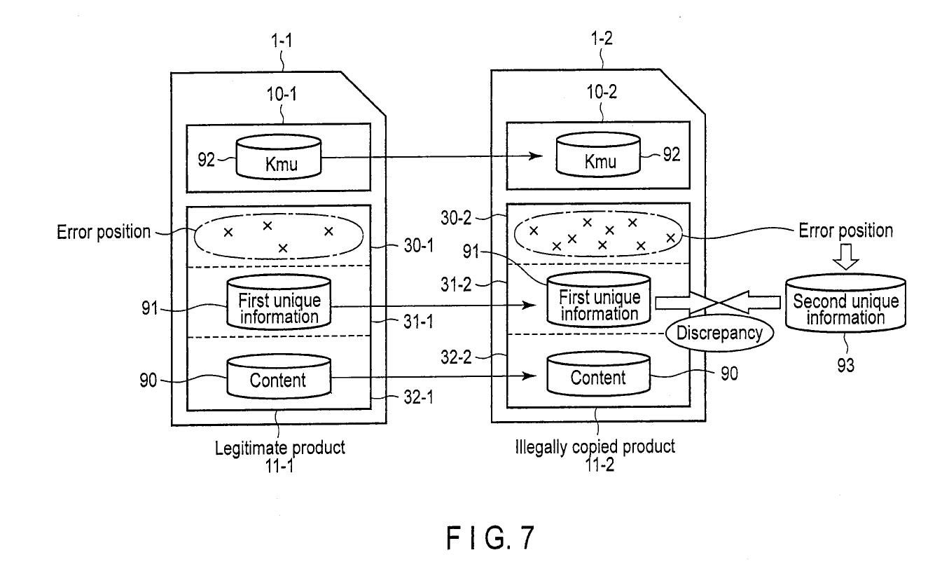

For example, consider a case as shown in FIG. 7. FIG. 7 shows a legitimate memory card 1-1 and an illegally copied memory card 1-2.

In the memory card 1-1, content 90 is recorded in a user region 32-1 and a controller 10-1 holds a media unique key 92. A secured region 31-1 holds first unique information 91. The information 91 coincides with the error position in a specialized region 30-1 of the memory card 1-1.

Suppose the content 90, media unique key 92, and first unique information 91 have been copied illegally into the memory card 1-2. When the content 90 in the memory card 1-2 is reproduced, second unique information 93 is generated using a specialized region 30-2 of the memory card 1-2. Then, the characteristic distribution of memory cells in the specialized region 30-1 differs from that in the specialized region 30-2. Therefore, of course, the second unique information 93 differs from the first unique information 91. As a result, the memory card 1-2 is determined to be an illegal card, preventing the content 90 from being reproduced.

In the first embodiment, when the first unique information and second unique information are generated, the specialized region 30 is written into and read from a plurality of times. This makes the method of the first embodiment more effective. Specifically, if the first unique information and second unique information are generated in only one write and read operation, the chances are very low that the former and the latter will coincide with each other. Therefore, the memory card might be determined to be an illegally copied card, although it is a legitimate recording medium. However, a write and read operation is carried out a plurality of times and only positions where the number of errors has exceeded a specific value are used, thereby excluding the bit positions where an error is less liable to occur from the first unique information and second unique information.

Furthermore, the first unique information and second unique information are generated on the basis of the data positions (or bit positions) where errors occur, thereby making the above method more easy-to-use. In a region where writing/reading fails, there are many defective memory cells. Therefore, use of memory blocks inhibited from being used (so-called bad blocks) is considered. It is, of course, desirable that the NAND flash memory should have as few bad blocks as possible. There is a product with very few bad blocks or no bad block. In such a case, if the first unique information and second unique information are generated using bad blocks, they will be totally meaningless information and therefore a digital signature will also be meaningless. In contrast, from the viewpoint of small data units, such as bit units, there are undoubtedly two or more errors. Therefore, it is desirable that a method according to the first embodiment should be used.

In addition, attaching a digital signature to the first unique information 91 contributes to content protection. In this way, the spread of clone cards is prevented, thereby protecting content effectively.

8. Modification

While in the first embodiment, the explanation has been given using a case where the first unique information and second unique information coincide with each other completely, they may not coincide with each other completely. That is, when they coincide with each other at a specific rate, it may be determined that the memory card is a legitimate product. Specifically, when the number of error positions in the first unique information is compared with that in the second unique information, if the percentage at which they coincide with each other is equal to a specific percent of the total number of error positions in the first unique information or second unique information, it may be determined that the memory card is a legitimate product.

For example, in the examples explained with reference to FIGS. 5 and 6, if a coincidence rate of 50% is acceptable, even when only either the sixth bit or sixteenth bit is included as the second unique information, it is determined that the memory card is a legitimate one. However, from the viewpoint of a high level of content protection, it is preferable to increase a required coincidence rate.

Data written in the memory card 1 might vary with time. Accordingly, the coincidence rate is set to less than 100%, thereby making the system of the first embodiment easier-to-use.

In addition, not only the coincidence rate but also the correlation between error positions included in the first unique information and second unique information may be taken into account. For example, the correlation between error positions is determined in advance. Even when the first unique information has not coincided with the second unique information in error positions, if the determined correlation between error positions is obtained with a certain amount, it may be determined that the memory card is a legitimate one.

For example, it is conceivable that the number of error positions in the second unique information generally increases more than that in the first unique information. The reason is that the characteristics of the memory cells deteriorate each time the specialized region 30 is written into/erased from. At this time, when the increased number of error positions is not more than a specific number or when the increasing rate is not more than a specific percent of the number of error positions in the first unique information, it may be determined that the memory card is a legitimate product.

Furthermore, in the first embodiment, the explanation has been given using a case where unique information has indicated bit positions where bits have been inverted in data. However, unique information is not limited to bit positions as long as information represents the bit positions. For instance, unique information may be represented by an address. The address is a physical address of a region where an error has occurred. The address is an address specifying the smallest memory region (e.g., cluster) that can be accessed by the writing apparatus 2 and reading apparatus 3.

### Second Embodiment

A recording apparatus, a writing apparatus, a reading apparatus, and a method of controlling the recording apparatus according to a second embodiment will be explained. The second embodiment relates to the details of an SD memory card 1 of the first embodiment. Therefore, a detailed explanation of a writing apparatus 2 and a reading apparatus 3 will be omitted.

1. Configuration of Memory Card

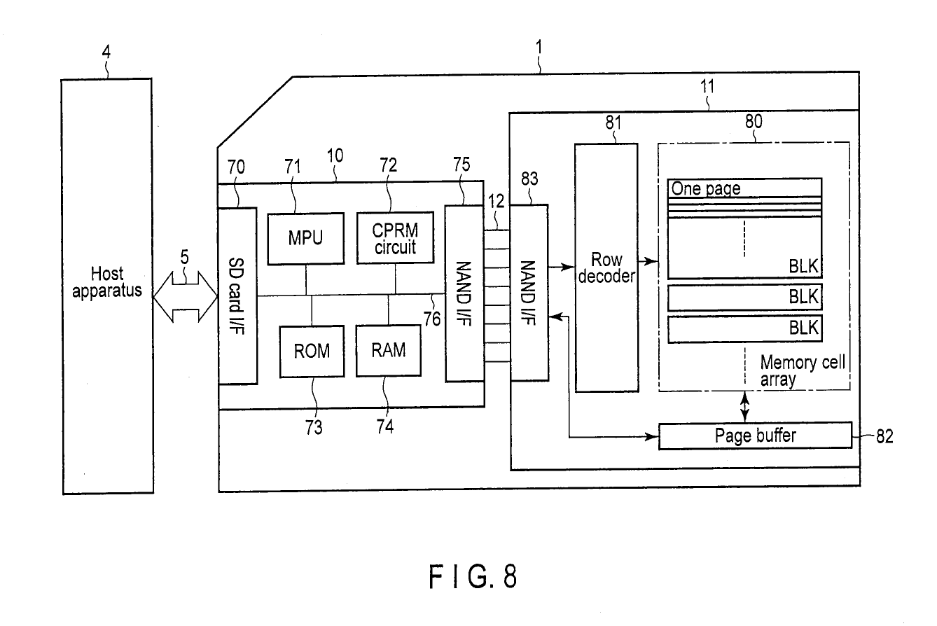

First, an overall configuration of a memory card 1 will be explained with reference to FIG. 8. FIG. 8 is a block diagram of the memory card 1 according to the second embodiment.

The memory card 1 can be connected to a host apparatus 4 via a bus interface 5. When the memory card 1 is connected to the host apparatus 4, electric power is supplied to the memory card 1, which then operates and performs processing according to access from the host apparatus 4. The host apparatus 4 corresponds to the writing apparatus 2 and reading apparatus 3 explained in the first embodiment.

The memory card 1 roughly includes the aforementioned memory controller 10, NAND flash memory 11, and a data bus 12. The memory controller 10 and NAND flash memory 11 are connected to each other with the data bus 12.

1.1 Configuration of Memory Controller 10

Next, the details of the memory controller 10 will be explained with reference to FIG. 8. As shown in FIG. 8, the memory controller 10 includes an SD card interface 70, an MPU 71, a Copy Protection for Prerecorded Media (CPRM) circuit 72, a ROM 73, a RAM 74, and a NAND interface 75. These are formed on a single semiconductor substrate and connected to one another via an internal bus 76 so as to communicate with one another.

The SD card interface 70, which can be connected to the host apparatus 4 via a bus interface 5 (SD card bus), supervises communication with the host apparatus 4. The NAND interface 75, which is connected to the NAND flash memory 11 via the data bus 12, supervises communication with the NAND flash memory 11.

The MPU 71 controls the operation of the entire memory card 1. For example, when electric power is supplied to the memory card 1, the MPU 71 reads firmware (control program) stored in the ROM 73 onto the RAM 74 and performs specific processing, thereby creating various tables on the RAM 74. Moreover, receiving a write-command, a read-command, or an erase-command from the host apparatus 4, the MPU 71 performs a specific process on the NAND flash memory 11 or controls a data transfer process. Some of the concrete functions the MPU 71 has will be explained in detail later.

The ROM 73 stores a control program controlled by the MPU 71 and others. The RAM 74, which is used as a work area of the MPU 71, stores the control program and various tables.

The CPRM circuit 72 supervises a copyright protection function of the memory card 1. That is, when the host apparatus 4 accesses information that should be made secret in the NAND flash memory 11, the CPRM circuit 72 determines whether to permit the access.

1.2 Configuration of NAND Flash Memory 11

Next, the configuration of the NAND flash memory 11 will be explained with reference to FIG. 8. As shown in FIG. 8, the NAND flash memory 11 includes a memory cell array 80, a row decoder 81, a page buffer 82, and an NAND interface 83.

The memory cell array 80 includes a plurality of memory blocks BLK. Each of the memory blocks is a set of memory cells capable of holding data. The memory cells are arranged in a matrix. A plurality of memory cells in the same row are connected to the same word line. Data is written en bloc into or read en bloc from the memory cells connected to the same word line. The unit is called a page. Each of the memory cells can hold 1-bit data (2-level mode) or 2-bit data (4-level mode. Data is erased in memory blocks BLK.

The NAND interface 83 supervises communication between the memory controller 10 and NAND interface 75 via the data bus 12. Then, the NAND interface 83 transfers a row address given by the memory controller 10 to the row decoder 81 and write data to the page buffer 82. In addition, the NAND interface 83 transmits data transferred from the page buffer 82 to a memory controller 10.

The row decoder 81 decodes a row address given by the NAND interface 83. According to the result of the decoding, the row decoder 81 selects a row direction of any one of the memory blocks BLK in the memory cell array 30. That is, the row decoder 81 selects any one of the pages.

The page buffer 82, which inputs data to or outputs data from the memory cell array 80, holds data temporarily. The page buffer 82 inputs data to or outputs data from the memory cell array 80 in pages. When writing data, the page buffer 82 holds write-data given by the NAND interface 83 temporarily and writes the data into memory cells. When reading data, the page buffer 82 holds read data temporarily and transfers the data to the NAND interface 83.

1.3 Function of Memory Controller 10

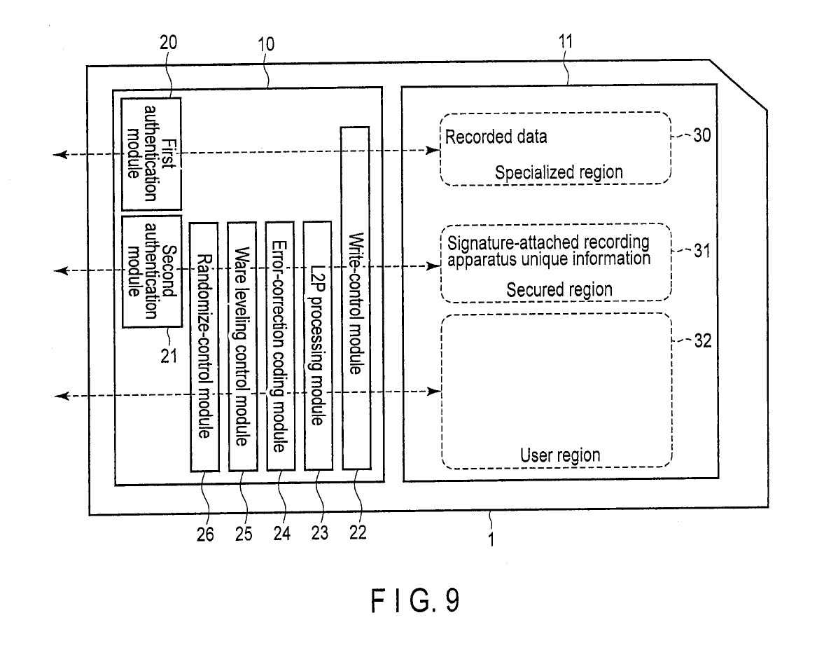

As described in the first embodiment, the memory controller 10 divides the memory area of the NAND flash memory 11 into a plurality of regions, specifically a specialized region 30, a secured region 31, and a user region 32, and manages these regions. Hereinafter, the function of the MPU 71 of the memory controller 10 to access the divided regions will particularly be explained with reference to FIG. 9. FIG. 9 is a functional block diagram of the memory card 1, showing the function the MPU 21 has and the divided regions.

As shown in FIG. 9, the MPU 71 of the memory controller 10 includes not only the first authentication module 20 and second authentication module 21 explained in the first embodiment but also a write-control module 22, a logical-address-to-physical-address conversion module (hereinafter, referred to as an L2P processing module) 23, an error-correction coding module (hereinafter, referred to as an ECC module) 24, a ware leveling control module 25, and a randomize control module 26. The MPU 71 may realize these functions by implementing software or with hardware or software independent of the MPU 71. The first authentication module 20 and the second authentication module 21 are as described in the first embodiment and therefore an explanation of them will be omitted.

The L2P processing module 23 converts a logical address given by the host apparatus 4 into a physical address (this process being referred to as an L2P process).

The ECC module 24 subjects data to error-correction coding. Specifically, when data is written, the ECC module 24 subjects data supplied from the host apparatus 4 to error-correction coding to generate a parity and adds this to the data. When data is read, the ECC module 24 generates a syndrome on the basis of the data read from the NAND flash memory 11. On the basis of the syndrome, the ECC module 24 detects an error position in the data and corrects the error data.

The ware leveling control module 25 subjects the NAND flash memory 11 to ware leveling. Ware leveling is a process of managing the number of rewrites for each of the memory blocks BLK so as to prevent data access from concentrating at a specific memory block BLK. For example, when data is written into memory block BLK1, if the frequency of writes in memory block BLK1 is high, the data is written into another memory block BLK2 whose frequency of writes is lower and the data already written in memory block BLK1 is copied into memory block BLK2.

The randomize control module 26 randomizes data supplied from the host apparatus 4 in writing data, thereby preventing “1” or “0” from continuing. Randomizing data is performed on the basis of, for example, logical exclusive OR operation of the pseudo-random number generated by a pseudo-random number generator and the data. When data is read, the randomize control module 26 decodes read data supplied from the NAND flash memory 11.

The write-control module 22 controls the L2P processing module 23, ECC module 24, ware leveling control module 25, and randomize control module 26. When writing data, the write-control module 22 generates a write-command defined in the NAND interface and outputs the write-command together with the physical address of a region to be written into and write-data to the NAND flash memory 11. When reading data, the write-control module 22 generates a read-command defined in the NAND interface and outputs the read-command together with the physical address of a region to be read from to the NAND flash memory 11.

With this configuration, the memory controller 10 causes the first authentication module 20 to authenticate the validity of access to the specialized region 30 from the host apparatus 4. The L2P processing module 23, ECC module 24, ware leveling control module 25, and randomize control module 26 do not perform processing. That is, the specialized region 30 is not subjected to an L2P process, an ECC process, and ware leveling. In addition, the data for the specialized region 30 is not randomized. In other words, the host apparatus 4 accesses the specialized region 30 using a physical address. In still other words, the memory card 1 treats an address received from the host apparatus 4 as a physical address, not a logical address. Then, when writing data, the write-control module 22 outputs the physical address, the data supplied from the host apparatus 4, and a write-command defined by the NAND interface to the NAND flash memory 11. At this time, the write-control module 22 writes data in the 4-level mode. When reading data, the write-control module 22 outputs a physical address and a read command to the NAND flash memory 11.

Furthermore, the memory controller 10 causes the second authentication module 21 to authenticate the validity of access to the secured region 31 from the host apparatus 4. Then, under the control of the write-control module 22, the L2P processing module 23, ECC module 24, ware leveling control module 24, and randomize control module 26 perform processing. That is, an L2P process, an ECC process, and ware leveling are performed. In addition, the data is randomized. Depending on circumstances, at least one of the ECC process, ware leveling, and data randomizing may be omitted. Then, when writing data, the write-control module 22 outputs a physical address obtained at the L2P processing module 23, randomized data to which a parity is added as needed, and a write-command to the NAND flash memory 11. At this time, the write-control module 22 writes data in the 2-level mode. When reading data, the write-control module 22 outputs a physical address and a read command to the NAND flash memory 11.

Access to the user region 32 is the same as access to the secured region 31, except that an authentication process at the second authentication module 21 is not needed.

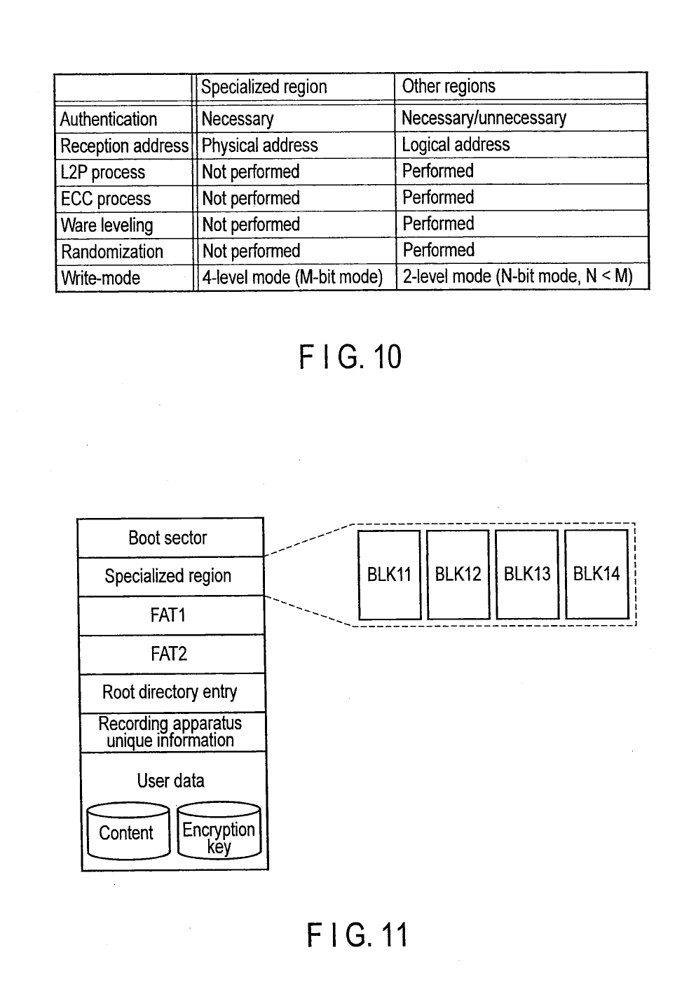

What has been described above is summarized as shown in FIG. 10. FIG. 10 is a table showing the difference between the specialized region 30 and other regions (the secured region 31 and user region 32) in terms of control by the memory controller 10.

As shown in FIG. 10, the specialized region 30 is subjected to an authentication process, but is not subjected to an ECC process, ware leveling, and randomizing. The specialized region 30 is controlled in the 4-level mode. In contrast, other regions 31, 32 are subjected to an authentication process as needed. They are also subjected to an L2P process, an ECC process, ware leveling, and randomizing. The data for the regions 31, 32 is controlled in the 2-level mode.

In the write mode, the amount of data held in the memory cells of the specialized region 30 should be greater than the amount of data held in the other regions 31, 32. For example, not less than 3-level data may be stored in the memory cells in the specialized region 30 and 2-level data in the other regions 31, 32. That is, the specialized region 30 may be controlled in a M-bit mode (M being a natural number not less than 2) and the other regions 31, 32 may be controlled in an N-bit mode (N being a natural number not less than 1 and satisfying the expression N<M).

A command for the host apparatus 4 to access the specialized region 30 (a command defined on the SD interface) may differ from a command to access the other regions 31, 32. This enables the memory controller 10 to easily recognize that the access is an access to the specialized region 30. Even if the same command is used, a region to be accessed can be distinguished on the basis of an address.

1.4 Memory Space of NAND Flash Memory 11

FIG. 11 is a conceptual diagram of a memory space of the NAND flash memory 11, showing information held in the NAND flash memory 11.

As shown in FIG. 11, the NAND flash memory 11 stores a boot sector, FAT1, FAT2, a root directory entry, first unique information, and user data. In addition, in the NAND flash memory 11, a certain region is secured as a specialized region 30. As described above, in this region, data for creating first unique information and second unique information is written.

The boot sector, FAT1, FAT2, and root directory entry are management information for managing files (data) recorded in the NAND flash memory 11. FIG. 11 shows a File Allocation Table (FAT) file system as an example. The user data includes contents, including music and movies, and encryption keys for encrypting/decrypting the contents.

As described above, the first unique information is written into the secured region 31. The FAT1, FAT2, root directory entry, and user data are written into the user region 42.

When the specialized region 30 is accessed, neither an L2P process nor ware leveling is performed. That is, memory blocks allocated to the specialized region 30 are fixed (e.g., BLK11 to BLK14). Therefore, when data is written into the specialized region 30, the data is written into any one of memory blocks BLK11 to BLK14. A place where data is to be written is selected directly by the host apparatus 4. In other words, a plurality of write and read operations carried out to generate first unique information and second unique information are performed on the same memory cells each time.

In contrast, memory blocks BLK allocated to the other regions are not fixed. Memory blocks BLK in which data is written are always changed when data is updated or ware leveling is done. That is, although the logical addresses themselves remain unchanged, their physical addresses vary with time.

2. Operation of Memory Card 1

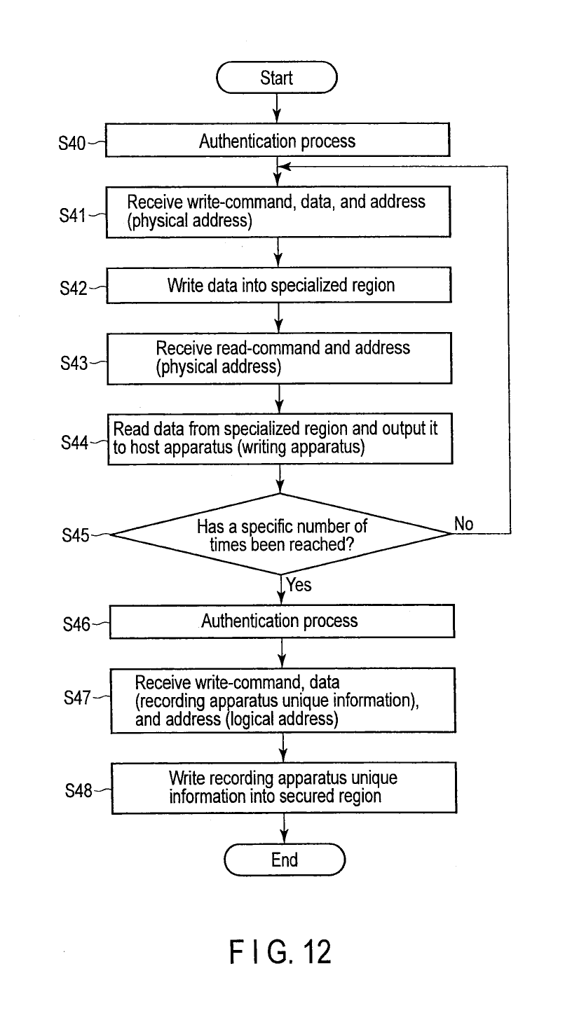

Next, the operation of the memory card 1 in creating and recording first unique information will be explained with reference to FIG. 12. FIG. 12 is a flowchart to explain the operation of the MPU 71 of the memory controller 10.

As shown in FIG. 12, first, by request of the writing apparatus 2, the first authentication module 21 carries out an authentication process (step S10 of FIG. 3 and step 40 of FIG. 12). If the authentication has failed, the memory controller 10 inhibits the writing apparatus 2 from accessing the memory card 1.

If the authentication has succeeded, the memory card 1 receives the write-command, data, and address (physical address) from the writing apparatus 2 (step S41). Then, the memory controller 10 writes the received data into a region corresponding to the received address, that is, the specialized region 30 (step S42). As described above, an L2P process, an ECC process, ware leveling, and a randomize process (of randomizing write data) are not performed.

The memory card 1 further receives a read-command and address (physical address) from the writing apparatus 2 (step S43). Then, the memory controller 10 reads data from a region corresponding to the received address, that is, the specialized region 30 (step S44). As described above, the L2P process, ECC process, and randomize process (or a process of returning read randomized data to the original one: a decode process) are not carried out.

The above read and write operations are repeated a specific number of times (n times) (step S45). Before the specialized region 30 is written into repeatedly, the memory controller 10 issues an erase-command and an address to the specialized region 30 and erases the data once. The CPU 40 of the writing apparatus 2 may issue an erase-command and an address to the specialized region 30 and erase the data once. As a result of the above processes, the writing apparatus 2 generates first unique information.

Thereafter, the first unique information is written into the memory card 1. Specifically, by request from the writing apparatus 2, the second authentication module 21 performs an authentication process in cooperation with the writing apparatus 2 (step S46). If the authentication has failed, the writing apparatus 2 is inhibited from accessing the memory card 1 from this time on.

If the authentication has succeeded, the memory card 1 receives a write-command, data (first unique information), and an address (logical address) from the host apparatus 2 (step S47). Then, the memory controller 10 writes the received data into a region corresponding to the received address, that is, the secured region 31 (step S48). At this time, the L2P process, ECC process, ware leveling, and randomizing are performed.

After the above processes, various contents are recorded in the memory card 1.

Processes when the memory card 1 is accessed by the reading apparatus 3 are almost the same. That is, after the processes in steps S40 to S46, the memory card 1 receives a read-command and an address (logical address). Then, the memory card 1 reads the first unique information from the secured region 31 and outputs the information to the reading apparatus 3.

3. Effects of the Second Embodiment

A memory card according to the second embodiment can not only generate unique information effectively but also suppress an illegal copy of unique information.

First, when accessing the specialized region 30, the memory card of the second embodiment neither carries out an L2P process nor performs ware leveling on the specialized region 30. That is, the allocation of memory blocks BLK to the specialized region 30 is fixed. Therefore, during the time from when first unique information is generated to when second unique information is generated, memory cells to be written into/read from are always the same. Consequently, the reliability of the method of authenticating the memory card of the second embodiment, that is, the method of authenticating the memory card by comparing the first unique information and second unique information with each other, can be improved.

When attention is focused only on the generation of the first unique information, it is desirable that an error should occur in many bits. The reason is that, if an error occurs in none of the bits, there is no target to which an digital signature is to be attached. In this respect, with the memory card 1 of the second embodiment, the specialized region 30 is not subjected to an ECC process and/or a randomize process. In addition, data with a larger number of bits than that in the memory cells of the user region 32 and secured region 31 is written into the memory cells of the specialized region 30. Accordingly, the error occurrence rate in the specialized region 30 can be increased, which enables recording apparatus unique information to be generated effectively.

The method of increasing the error occurrence rate in the specialized region 30 may be realized by another way. For instance, one method is to vary the voltage applied to the word lines WL connected to the memory cells in the specialized region 30 in comparison with the other regions 31, 32. Specifically, the read-voltage applied to a word line to be read from may be shifted to a value higher than usual. Alternatively, the verify-voltage in writing may be shifted to a value lower than usual without varying the read-voltage.

Furthermore, the method of increasing the error occurrence rate in the specialized region 30 may be to write a data pattern considered to have a higher error occurrence rate into the memory cells in the specialized region 30. With the memory card of the second embodiment, since randomizing is not performed on the specialized region 30, an arbitrary data pattern can be written directly into memory cells. Alternatively, if there are word lines whose error occurrence rate is high in blocks of the specialized region 30, only these word lines may be used.

Moreover, in the second embodiment, data has been written and read repeatedly in steps S41 to S45 of FIG. 12. However, data need not necessarily be written each time. That is, after data has been written in the specialized region 30 for the first time, the data may be read a specific number of times. Thus, on the basis of errors that occurred in the read-data, it may be determined whether the memory card is a clone card. In this case, the effect of preventing the recording element from deteriorating is obtained. This holds true for the operation of the reading apparatus (steps S21 to S25 of FIG. 4).

In addition, when writing is performed to generate unique information (steps S12, S22 in FIGS. 3 and 4), not all of but a part of the specialized region 30 may be used. Then, according to the situation after that, a place where data for creating unique information is to be written may be changed. A criterion for changing the place is, for example, an error correction rate of ECC. Specifically, when the number of error corrections of ECC in data written in a certain place has exceeded a specific number of times, the region is considered to be a site where errors occur too frequently. After that, another place is used as a region for creating unique information.

In the second embodiment, unique information has been written in the secured region 31. However, unique information may be written in the ordinary user region 32. Alternatively, unique information may be determined to be specific data in advance between recording apparatuses and not be recorded in a memory card. That is, what data is used as unique information may be determined in advance and the writing apparatus and reading apparatus may share the information. It is permitted for the memory card to hold what has been written as unique information when the reading apparatus reads unique information. Alternatively, the reading apparatus may know unique information beforehand without the unique information being recorded in the memory card.

### Third Embodiment

Next, a recording apparatus, a writing apparatus, a reading apparatus and a method of controlling the recording apparatus according to a third embodiment will be explained. The third embodiment shows an example of the encryption and decryption of content in the first and second embodiments.

1. Encryption Method

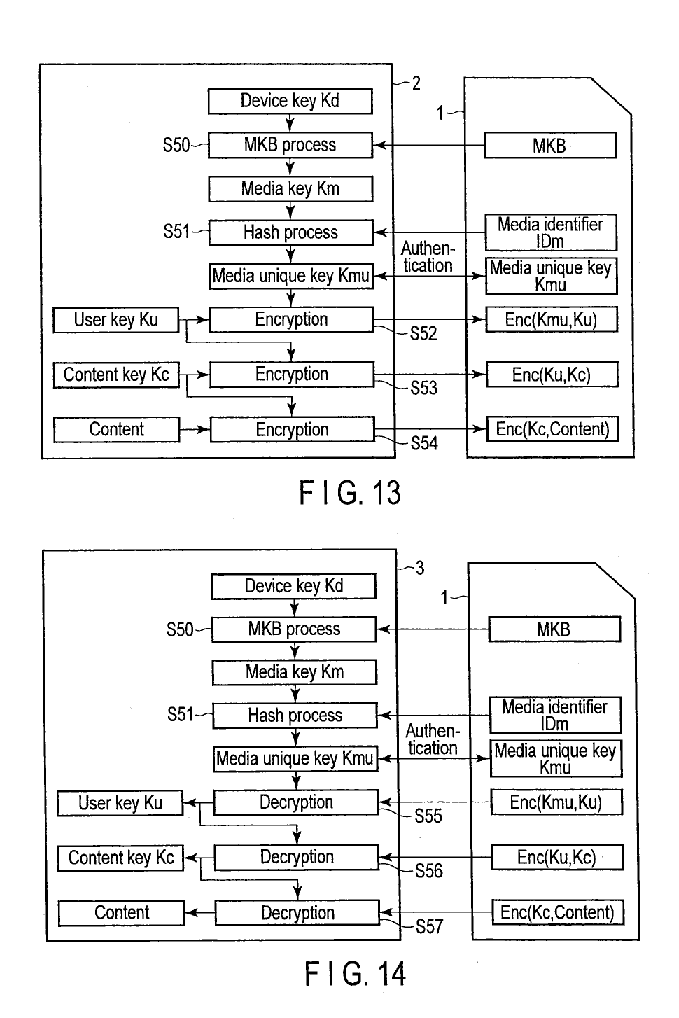

First, an encryption method will be explained with reference to FIG. 13. FIG. 13 is a block diagram of a memory card 1 and a writing apparatus 2, particularly showing the flow of information and processing necessary for encryption.

As shown in FIG. 13, the writing apparatus 2 has a preset device key Kd and the memory card 1 has key management information MKB (Media Key Block). The writing apparatus 2 reads an MKB from the memory card 1 and executes an MKB process using its own device key Kd, thereby obtaining a media key Km (step S50).

Next, the writing apparatus 2 reads a media identifier IDm from the memory card 1 and performs a hash process using the media identifier IDm and media key Km (step S51). As a result of the hash process, the writing apparatus 2 obtains a media unique key Kmu. The above processes are carried out by, for example, the CPU 40.

Thereafter, on the basis of the obtained media unique key Kmu, the writing apparatus 2 performs an authentication process and key exchange in cooperation with the memory card 1. This is carried out by, for example, the second authentication modules 43, 21. As a result of the authentication and key exchange, the writing apparatus 2 shares a session key Ks with the memory card 1. This process succeeds when the media unique key Kmu of the writing apparatus 2 coincides with the media unique key Kmu held in the memory card 1, with the result that the session key Ks is shared.

Next, the writing apparatus 2 encrypts a user key Ku using the media unique key Kmu (step S52) and writes the encrypted key into the secured region 31 of the memory card 1 by cipher communication using the session key Ks. In FIG. 13, the user key Ku encrypted with the media unique key Kmu is represented as Enc (Kmu, Ku). This encryption is performed by any one of the encryption modules (not shown) of the content encryption module 44 of FIG. 1.

Furthermore, the writing apparatus 2 encrypts a content key Kc using the user key Ku (step S53) and writes the encrypted key into the user region 32 of the memory card 1. In FIG. 13, the content key Kc encrypted with the user key Ku is represented as Enc (Ku, Kc). The encryption is performed by, for example, a first encryption module 48.

In addition, the writing apparatus 2 encrypts content using the content key Kc (step S54) and writes the encrypted content into the user region 32 of the memory card 1. In FIG. 13, the content encrypted with the content key Kc is represented as Enc (Ku, content). The encryption is performed by, for example, a second encryption module 49.

2. Decryption Method

Next, a decryption method will be explained with reference to FIG. 14. FIG. 14 is a block diagram of a memory card 1 and a reading apparatus 3, particularly showing the flow of information and processing necessary for decryption.

As shown in FIG. 14, the reading apparatus 3 performs an authentication process and key exchange in cooperation with the memory card as in encryption. The processes up to now are carried out by the CPU 50 and second authentication module 53.

Next, the reading apparatus 3 reads an encrypted user key Enc (Kmu, Ku) from the secured region 31 of the memory card 1 and decrypts the encrypted key using a media unique key Kmu held in itself (step S55), thereby obtaining a user key Ku. The decryption is performed by any one of the decryption modules (not shown) in the content decryption module 54 of FIG. 2.

Furthermore, the reading apparatus 3 reads an encrypted content key Enc (Ku, Kc) from the user region 32 of the memory card 1 and decrypts the encrypted content key using the user key Ku (step S56), thereby obtaining a content key Kc. The decryption is performed by, for example, a first decryption module 59.

Then, the reading apparatus 3 reads an encrypted content Enc (Kc, Content) from the user region 32 of the memory card 1 (step S57), thereby obtaining content. The decryption is performed by, for example, a first decryption module 60.

In addition, already recorded data may be read a specific number of times without being overwritten instead of reading the data each time the data has been written into the specialized region 30. Thus, a method of using errors occurred in the read data may be used. In this case, since writing is not performed, the deterioration of the recording elements can be prevented. This is the same as described in the second embodiment.

3. Effects of the Third Embodiment

The aforementioned method can be used for the encryption and decryption of content. However, the third embodiment is only illustrative and various suitable methods may be used.

In addition, the media identifier IDm of the memory card 1 may be generated on the basis of the first unique information. Specifically, after the process of FIG. 3 explained in the first embodiment, the media IDm already held in the memory card 1 is processed on the basis of the generated first unique information. Alternatively, a media IDm may be newly generated on the basis of the first unique information. Still alternatively, the first unique information may be used as a media identifier IDm. This enables the protection of content to be increased further.

Furthermore, the writing apparatus may record in a digital signature a serial number which are allocated to each writing apparatus, time, and a value obtained by concatenating serial number and may use the value as a media identifier. This enables the writing apparatus to prevent its media identifier from coinciding with the value of another medium by accident.

### Fourth Embodiment

Next, a recording apparatus according to a fourth embodiment will be explained. The fourth embodiment is such that the recording apparatus is applied to a Solid State Drive (SSD) in the first to third embodiments.

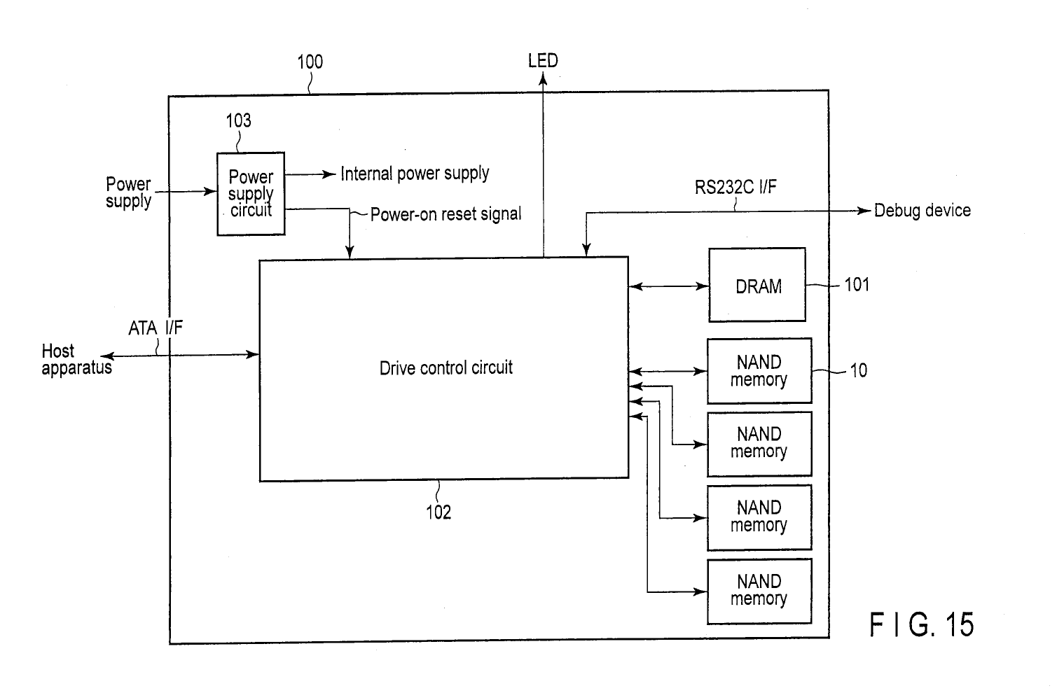

FIG. 15 is a block diagram showing the configuration of an SSD 100. As shown in FIG. 15, the SDD 100 includes a plurality of NAND flash memories (NAND memories) 10 for data storage, a DRAM 101 for data transfer or work area, a drive control circuit 102 for controlling these, and a power supply circuit 103. The drive control circuit 102 outputs a control signal for controlling a status display LED provided outside the SSD 100. A ferroelectric random access memory (FeRAM) may be used in place of the DRAM 101.

The SSD 100 transmits and receives data to and from a host apparatus, such as a personal computer, via an ATA interface (ATA I/F). The SSD 100 also transmits and receives data to and from a debug unit via an RS232C interface (RS232C I/F)).

The power supply circuit 103 receives an external power supply and generates a plurality of internal power supplies using the external power supply. These internal power supplies are supplied to various parts of the SDD 100. In addition, the power supply circuit 103 detects the rising of the external power supply and generates a power-on reset signal. The power-on reset signal is sent to the drive control circuit 102.

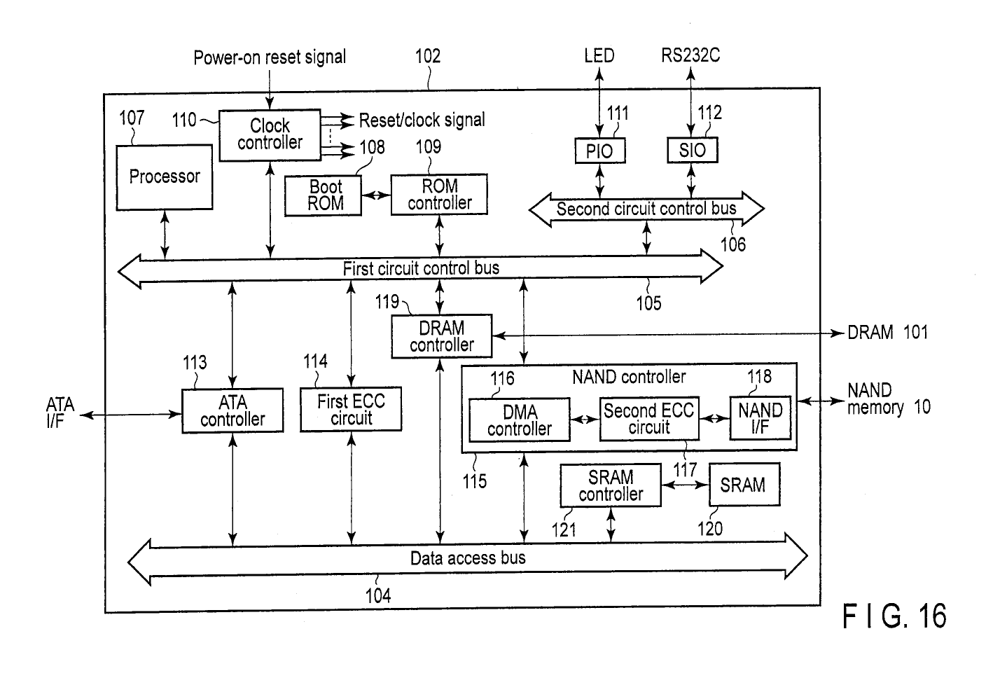

FIG. 16 is a block diagram showing the configuration of the drive control circuit 102. The drive control circuit 102 includes a data access bus 104, a first circuit control bus 105, and a second circuit control bus 106.

A processor 107 which controls the entire drive control circuit 102 is connected to the first circuit control bus 105. A boot ROM 108 in which a boot program for various management programs (FW: firmware) has been stored is also connected to the first circuit control bus 105 via a ROM controller 109. Further connected to the first circuit control bus 105 is a clock controller 110 which receives a power-on reset signal from the power supply circuit 103 and supplies a reset signal and a clock signal to various parts.

The second circuit control bus 106 is connected to the first circuit control bus 105. Connected to the second circuit control bus 106 are a parallel IO (PIO) circuit 111 which supplies a status display signal to a status display LED and a serial IO (SIO) circuit 112 which controls an RS232C interface.

An ATA interface controller (ATA controller) 113, a first Error Check and Correct (ECC) circuit 114, a NAND controller 115, and a DRAM controller 119 are connected to both the data access bus 104 and the first circuit control bus 105. The ATA controller 113 transmits and receives data to and from the host apparatus via the ATA interface. An SRAM 120 used as a data work area is connected to the data access bus 104 via the SRAM controller 121.

The NAND controller 115 includes a NAND interface circuit (NAND I/F) 118 which interfaces with four NAND memories 10, a second ECC circuit 117, and a DMA controller 116 for DMA transfer control which performs access control between NAND memory and DRAM.

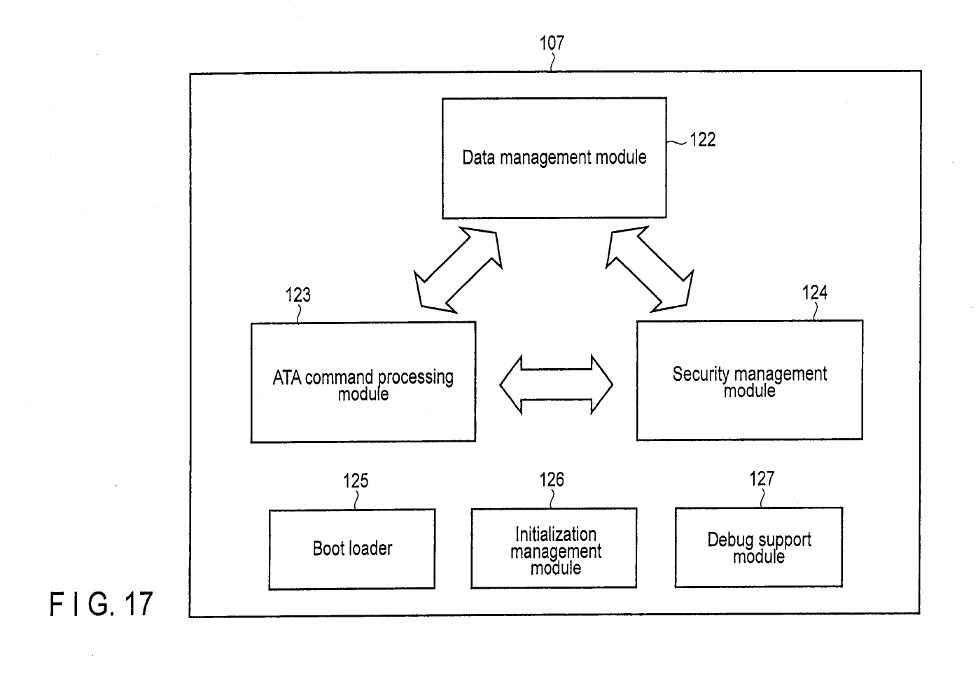

FIG. 17 is a block diagram showing the configuration of the processor 107. The processor 107 includes a data management module 122, an ATA command processing module 123, a security management module 124, a boot roader 125, an initialization management module 126, and a debug support module 137.

The data management module 122 controls data transfer between NAND memory and DRAM via the first ECC circuit and various functions related to a NAND chip.

The ATA command processing module 123 carries out a data transfer process in cooperation with the data management module 122 via the ATA controller 113 and DRAM controller 119. The security management module 124 manages various pieces of security information in cooperation with the data management module 122 and ATA command processing module 123. The security management module 124 performs processes carried out by, for example, the first authentication module 20 and second authentication module explained in the second embodiment.

The boot roader 125 loads various management programs (FW) from the NAND memory 10 into the SRAM 120 when the power supply is turned on. The initialization management module 126 initializes various controllers/circuits in the drive control circuit 102. The debug support module 127 processes debug data externally supplied via the RS232C interface.

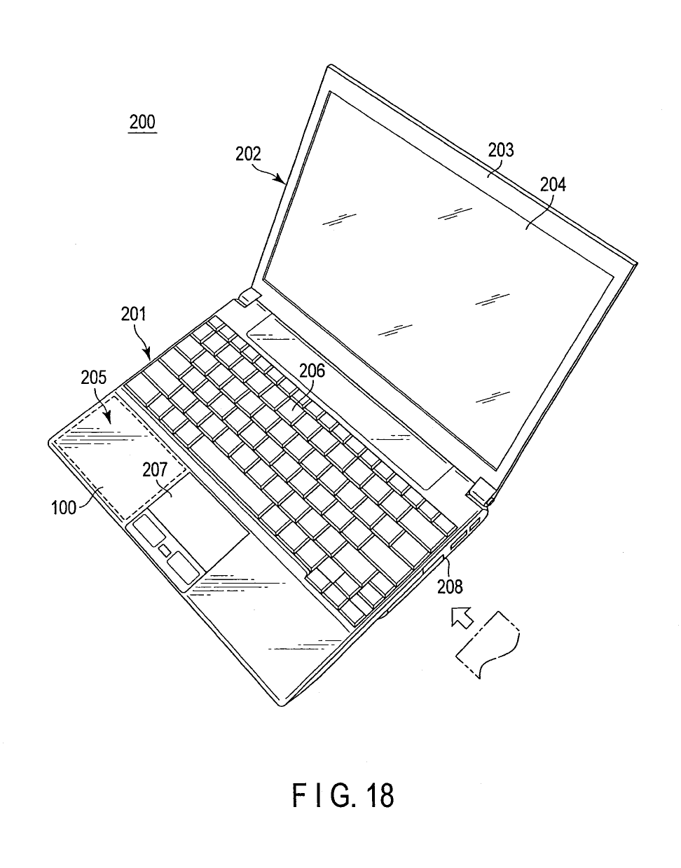

FIG. 18 is a perspective view of a portable computer 200 embedded with the SSD 100. The portable computer 200 includes a body 201 and a display unit 202. The display unit 202 includes a display housing 203 and a display device 204 set in the display housing 203.

The body 201 includes a chassis 205, a keyboard 206, and a touch pad 207 acting as a pointing device. The chassis 205 houses a main circuit board, an optical disk device (ODD) unit, a card slot, and the SSD 100, etc.

The card slot is provided adjacent to the peripheral wall of the chassis 205. In the peripheral wall, an opening 208 is made so as to face the card slot. The user can insert an additional device into the card slot through the opening 208 from outside the chassis 205.

The SSD 100 may be used as a substitution of a conventional HDD by being embedded in the portable computer 200 or used as an additional device by being inserted in the card slot of the portable computer 200. Alternatively, the SSD 100 may be used as a USB external device. In addition, the writing apparatus 2 and reading apparatus 3 explained in the first embodiment may be embedded into the portable computer 200. The portable computer 200 may be used as a recording and reproducing device for content, such as movies distributed through the Internet or the like.

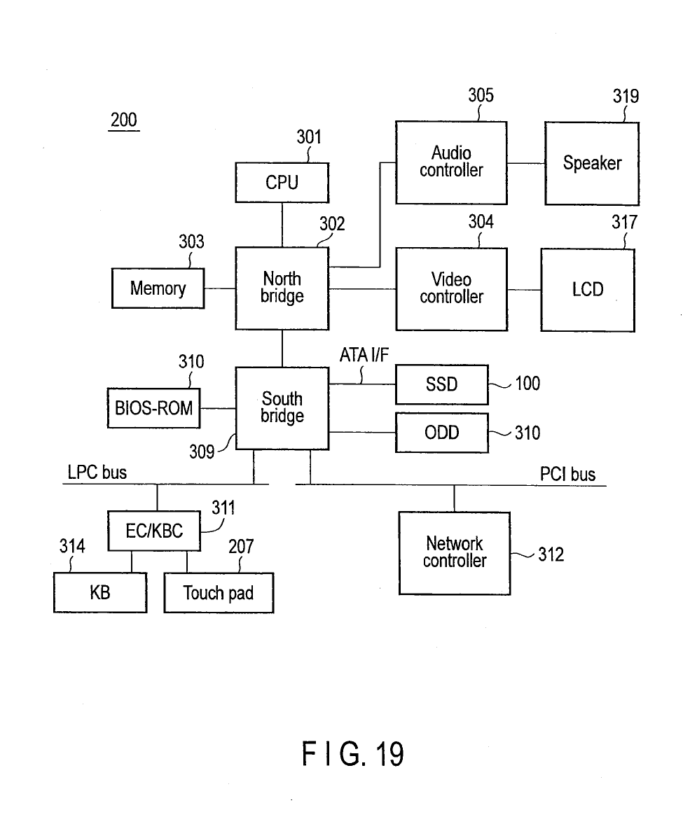

FIG. 19 shows a system configuration of the portable computer 200 embedded with the SSD 100. The portable computer 200 includes a CPU 301, a north bridge 302, a main memory 303, a video controller 304, an audio controller 305, a south bridge 306, a BIOS-ROM 307, an SSD 100, an ODD unit 308, an embedded controller/keyboard controller IC (EC/KBC) 309, and a network controller 310.

The CPU 301, which is a processor provided to control the operation of the portable computer 200, executes an operating system (OS) loaded from the SSD 100 into the main memory 303. In addition, when the ODD unit 308 enables at least one of a read process and a write process to be performed on the installed optical disk, the CPU 301 carries out the process.

Furthermore, the CPU 301 also executes a system Basic Input Output System (BIOS) stored in the BIOS-ROM 307. The system BIOS is a program for controlling the hardware of the portable computer 200.

The north bridge 302 is a bridge device that connects the local bus of the CPU 301 and the south bridge 306. The north bridge 302 houses a memory controller that performs access control of the main memory 303.

The north bridge 302 also has the function of communicating with the video controller 304 via an Accelerated Graphics Port (AGP) bus and, further, communicating with the audio controller 305.

The main memory 303 stores a program or data temporarily and functions as a work area of the CPU 301. The main memory 303 is, for example, a DRAM.

The video controller 304 is a video reproduction controller that controls a display unit (LCD) 202 used as a display monitor of the portable computer 200.

The audio controller 305 is an audio reproduction controller that controls a speaker 311 of the portable computer 200.

The south bridge 306 controls each device on a Low Pin Count (LPC) bus and each device on a Peripheral Component Interconnect (PCI) bus. The south bridge 306 also controls the SSD 100, a storage unit for storing various types of software and data, via the ATA interface.

The portable computer 200 accesses the SSD 100 in sectors. A write-command, a read-command, a flash command, and the like are input to the SSD 100 via the ATA interface.

The south bridge 306 also has the function of performing access control of the BIOS-ROM 307 and ODD unit 308.

The EC/KBC 309 is a one-chip microcomputer into which an embedded controller for power management and a keyboard controller for controlling the keyboard (KB) 206 and touch pad 207 have been integrated.

The EC/KBC 309 has the function of turning on or off the power supply of the portable computer 200 according to the user operation of a power button 312. The network controller 310 is a communication device that communicates with an external network, such as the Internet.

In the above configuration, at least one of the NAND flash memories 10 shown in FIG. 15 is provided with a specialized region 30 (and a secured region 31). Then, the writing apparatus 2 and reading apparatus 3 access the specialized region (and secured region 31) of the SSD and determine whether the SSD is a legitimate recording medium.

The first to third embodiments may be applied not only to the SDD but also to other recording media, including a hard disk or a DVD.

[Modification and Others]

As described above, a recording apparatus according to the first to fourth embodiments includes a memory 11 which is capable of recording data and a controller 10 which divides the memory 11 into a first region 30 and a second region 31 and controls the recording of data. The controller 10 writes externally supplied data into the first region 30 without performing error correction coding and address conversion of a logical address into a physical address for the externally supplied data. The data is subjected to the error correction coding and address conversion and resulting data is written into the second region 31.

In addition, a writing apparatus 2 according to the first to fourth embodiments includes a providing module 47 which provides data and a processing module 46. The processing module 46 writes data provided by the providing module 47 into the first region 30 of the recording apparatus 1, reads the written data, compares the written data with the read data, and writes information (first unique information) based on the data positions where the former differs from the latter into the second region 31 of the recording apparatus 1.

Furthermore, a reading apparatus 3 according to the first to fourth embodiments comprises a providing module 57 which provides data, a processing module 56, and a comparison module 58. The processing module 56 writes data provided by the providing module 57 into the first region 30 of the recording apparatus 1, reads the written data, compares the written data with the read data, and generates first information (second unique information) based on the data positions where the former differs from the latter. The comparison module reads second information (first unique information) from the second region 31 of the recording apparatus 1, compares the second information with the first information (second unique information) generated by the processing module 56, and determines on the basis of the comparison result whether the recording apparatus 1 is a legitimate recording apparatus.

With the above configuration, unauthorized use of content data can be suppressed. Embodiments are not limited to the above embodiments and may be modified variously.

As described above, the recording apparatus 1 is not limited to an SD memory card and may be other recording media capable of storing data. The semiconductor memory is not restricted to a NAND flash memory and may be a NOR flash memory or other suitable semiconductor memory. The recording apparatus 1 is not limited to a card device and may be applied to a wide variety of recording media, including a magnetic recording medium and an optical recording medium.

In addition, it is desirable that a certain number of errors should occur when the first unique information and second unique information are generated. Therefore, it is preferable to use a method of making an error more liable to occur in the specialized region 30 than in the secured region 31 and user region 32 as a method of writing or reading data into or from the specialized region 30. While, in the embodiments, a method of not performing ware leveling, ECC processing, or randomizing has been explained as an example of the above method, another method may be applied. For instance, in a flash memory, the voltage applied to the gate (word line) of a memory cell may be made higher in the specialized region 30 than in the secured region 31 and user region 32. This enables stress on the memory cells in the specialized region 30 to be made greater. In addition, writing data with a series of “1” or “0” also enables the error occurrence rate to be increased. Accordingly, data with all bits being “1” or data with all bits being “0” may be used. Alternatively, data with not less than a specific number of consecutive “1” or “0” may be used.

While in the above embodiments, a Kiosk terminal, a content provider, or a content reproducing device has been used as an example of the writing apparatus 2, another suitable device may be used. For instance, a suitable device on the side of the manufacturer of memory card 1 may be used as an example of the writing apparatus 2. In this case, the manufacturer writes first unique information into the memory card 1 and sells the card. Alternatively, a suitable device on the side of a content provider's organization may be used as an example of the writing apparatus 2. In this case, first unique information may be written into the memory card 1 purchased by a user via the Internet or the like. When the writing apparatus 2 provides only first unique information, not content, the content encryption module 44 is not needed.

In addition, a content reproducing device has been used as an example of the reading apparatus 3. However, another suitable device may be used as an example of the reading apparatus 3. If a content reproducing device is not used, the decryption module is not needed.

Moreover, at least one of the time, date, and ambient temperature may be included in a digital signature attached to the first unique information. For instance, when the time or date is included and a specific length of time has elapsed since the time or date included in the digital signature, the signature verification module 55 may permit content to be reproduced on the assumption that the period during which an illegal copy should be prevented more reliably has passed, regardless of the result of comparison between the first unique information and the second unique information. Alternatively, at that time, the digital signature may be updated. That is, a signature may be newly generated and the newly generated digital signature may be written in the recording apparatus.

Furthermore, when temperature information is included in the digital signature, first unique information may be generated at a plurality of temperatures. For instance, first unique information generated at a high temperature and first unique information generated at a low temperature may be recorded in the specialized region 30. When verification is performed at the reading apparatus 3, either first unique information closer to the present temperature may be used. Depending on circumstances, first, the temperature in the digital signature may be checked and the process of FIG. 4 may be carried out with the ambient temperature set to the checked temperature when verification is performed at the reading apparatus 3. When temperature information is included in the digital signature, a temperature sensor is required in each of the writing apparatus 2 and reading apparatus 3. Although neither the writing apparatus 2 nor the reading apparatus 3 has a temperature sensor, temperature information may be obtained from another device. For example, the SDD explained in the fourth embodiment has a temperature sensor in it. Therefore, in the processes of FIGS. 3 and 4, the temperature measured at the SDD may be output to the writing apparatus 2 and reading apparatus 3.

Moreover, information on the voltage used in writing data into the specialized region 30, for example, the word line voltage, may be included in the digital signature. In this case, in the reading apparatus 3, first, the word line voltage may be checked from the digital signature and data may be written into the specialized region 30 using the word line voltage.

Furthermore, in the third embodiment, the first unique information has also been used as a media identifier IDm. However, the first unique information may be used as information unique to each memory card 1 in a variety of applications. In addition, the contents included in the first unique information and second unique information are not limited to error positions and may be any suitable information unique to a memory card 1 on the basis of error positions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording apparatus comprising:
a memory which is capable of recording data; and
a controller which divides the memory into a first region and a second region and controls the recording of the data,
wherein the controller writes externally supplied data into the first region without performing error correction coding and address conversion of a logical address into a physical address for the externally supplied data, and
performs the error correction coding and the address conversion for the data, and then writes resulting data into the second region.

2. The apparatus according to claim 1, wherein the controller writes content data and write- or read-error information on the first region into the second region, and
the write- or read-error information is used to determine whether to permit or inhibit access to the memory.

3. The apparatus according to claim 1, wherein the controller does not perform ware leveling on the first region and performs ware leveling on the second region.

4. The apparatus according to claim 1, wherein the memory includes a plurality of memory cells each capable of holding data, and
the controller writes M-bit data (M being a natural number not less than 2) into each of the memory cells in the first region and N-bit data (N being a natural number not less than 1 and satisfying the expression N<M) into the memory cells in the second region.

5. The apparatus according to claim 1, wherein the memory includes a plurality of memory cells each capable of holding data, and
the controller causes the memory cells in the first region to hold not less than 3-level data and each of the memory cells in the second region to hold 2-level data.

6. The apparatus according to claim 1, wherein the controller does not randomize data in the first region and randomizes data in the second region.

7. The apparatus according to claim 1, wherein the controller has a first operation mode and a second operation mode,
in the first operation mode, accepts an input of a physical address of the memory from the outside and accesses a region directly specified by the physical address, and
in the second operation mode, accepts the input of a logical address of the memory from the outside and accesses a region specified by converting the logical address into a physical address.

8. A writing apparatus comprising:
a providing module which provides data; and
a processing module which writes the data provided by the providing module into a first region of a recording apparatus, reads the written data, compares the written data with the read data, and writes information on the basis of a data position where the written data and the read data differ from each other into a second region of the recording apparatus.

9. The apparatus according to claim 8, wherein the processing module performs the writing, reading, and comparison a plurality of times and generates the information on the basis of a position where the written data and read data differ from each other not less than a specific number of times.

10. The apparatus according to claim 8, wherein the processing module accesses the first region by use of a physical address and the second region by use of a logical address.

11. The apparatus according to claim 8, further comprising:
a signature generation module which generates a digital signature for the information generated by the processing module and attaches the signature to the information,
wherein the processing module writes digital-signature-attached information into the recording apparatus.

12. The apparatus according to claim 11, wherein the digital signature includes at least one of a date, a time, and an ambient temperature when the signature was attached.

13. A reading apparatus comprising:
a providing module which provides data;
a processing module which writes the data provided by the providing module into a first region of a recording apparatus, reads the written data, compares the written data with the read data, and generates first information on the basis of a data position where the written data and the read data differ from each other; and
a comparison module which reads second information from a second region of the recording apparatus, compares the second information with the first information generated by the processing module, and determines according to the comparison result whether the recording apparatus is a legitimate recording apparatus.

14. The apparatus according to claim 13, wherein the processing module performs the writing, reading, and comparison a plurality of times and generates the first information on the basis of a position where the written data and read data differ from each other not less than a specific number of times.

15. The apparatus according to claim 13, wherein the processing module accesses the first region by use of a physical address and the second region by use of a logical address.

16. The apparatus according to claim 13, further comprising: a signature verification module which verifies whether a digital signature attached to the second information is correct and determines according to the verification result whether the recording apparatus is a legitimate recording apparatus.

17. The apparatus according to claim 13, wherein the second information is information which is based on a data position where the writing or reading of data into or from the first region has failed and has been generated earlier than the first information.
